(19) United States
(12) Patent Application Publication
(10) Pub. No.: US 2010/0271822 A1
(43) Pub. Date: Oct. 28, 2010

(54) LED LAMP

(75) Inventors: QIANG LUO, Shenzhen City (CN); GUANG YU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/535,674

(22) Filed: Aug. 4, 2009

(30) Foreign Application Priority Data
Apr. 23, 2009 (CN) 200910301789.3

(51) Int. Cl. F21S 4/00; F21V 29/00

(52) U.S. Cl. 362/249.02; 362/373

(57) ABSTRACT

An LED lamp includes a heat sink and a plurality of LED modules attached to a bottom of the heat sink. The heat sink includes a heat spreader having a heat dissipating portion curved downwardly and a mounting portion horizontally extending from an end of the heat dissipating portion. A plurality of fins upwardly extend from a curved top of the heat dissipating portion. The LED modules are attached to a bottom of the heat dissipating portion of the heat spreader of the heat sink.

### BACKGROUND

1. Technical Field

The present disclosure relates to an LED (light emitting diode) lamp and, more particularly, to an LED lamp having a heat sink for heat dissipation.

2. Description of Related Art

The technology of light emitting diode (LED) has been rapidly developed in recent years from indicators to illumination applications. With the features of long-term reliability, environment friendliness and low power consumption, the LED is viewed as a promising alternative for future lighting products. Nevertheless, the rate of heat generation increases with the illumination intensity. This issue has become a challenge for engineers to design the LED illumination, i.e. the LED lamp.

What is needed, therefore, is an LED lamp which has greater heat-transfer and heat dissipation capabilities, whereby the LED lamp can operate normally for a sufficiently long period of time.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric, assembled view of an LED lamp in accordance with an embodiment of the disclosure.

FIG. 2 is an exploded view of the LED lamp of FIG. 1.

FIG. 3 is an inverted view of the LED lamp of FIG. 2.

FIG. 4 is a partially assembled view of the LED lamp of FIG. 1.

### DETAILED DESCRIPTION

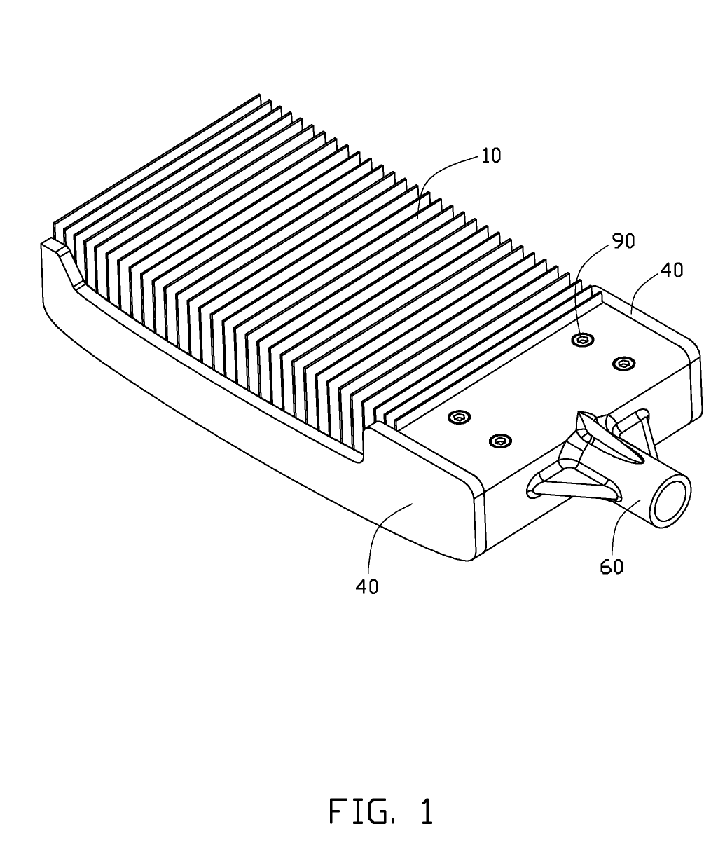

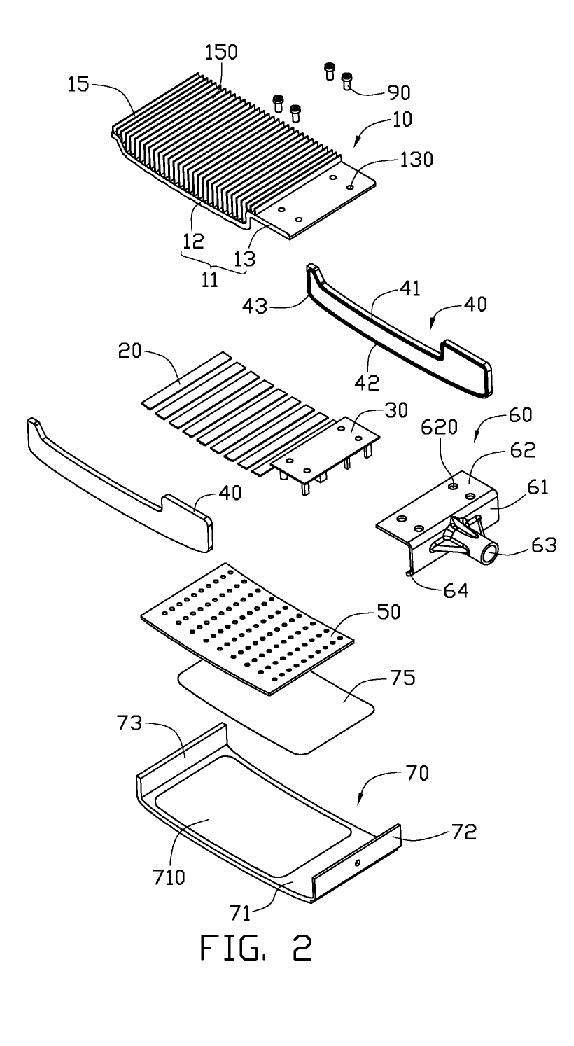

Referring to FIGS. 1-2, an LED lamp in accordance with an embodiment of the disclosure is illustrated. The LED lamp comprises a heat sink 10, a plurality of LED modules 20 and a driving circuit module 30 mounted on a bottom of the heat sink 10, a reflector 50 mounted on the LED modules 20, a face plate 70 covering the LED modules 20, and two lateral walls 40 located at two sides of the heat sink 10 and the face plate 70. The driving circuit module 30 electrically connects the LED modules 20. A connector 60 engages with a front end of the heat sink 10.

The heat sink 10 is integrally formed of a metal with a good heat conductivity such as aluminum, copper or an alloy thereof. In this embodiment, the heat sink 10 is made of aluminum extrusion and is extruded along a direction from one lateral side to another lateral side of the heat sink 10. The heat sink 10 comprises a heat spreader 11 and a plurality of fins 15 extending from a top of the heat spreader 11. The heat spreader 11 is curved downwardly thereby to have an arc-shaped heat dissipating portion 12 and a flat mounting portion 13 horizontally extending from a front end of the heat dissipating portion 12. A bottom surface of the mounting portion 13 is higher than a bottom surface of the dissipating portion 12 thereby to define a space under the bottom surface of the mounting portion 13. The fins 15 extend upwardly from a top surface of the heat dissipating portion 12, and a driving circuit module 30 is mounted on the bottom surface of the mounting portion 13; thus, the arced heat spreader 11 with the fins 15 and the driving circuit module 30 have a compact structure. The fins 15 are parallel to each other to form a plurality of channels 150 therebetween for flow of cool air therethrough. Top ends of the fins 15 are coplanar and near a top surface of the mounting portion 13. The mounting portion 13 defines a plurality of screw holes 130 therethrough.

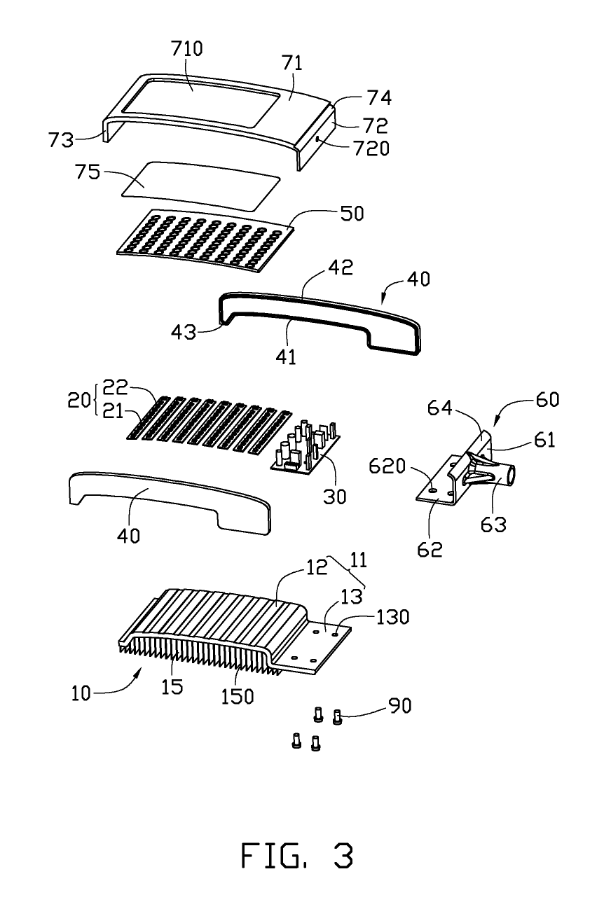

Referring to FIG. 3, each of the LED module 20 comprises a linear printed circuit board 21 and a plurality of LEDs 22 evenly mounted on the printed circuit board 21. The LED module 20 is mounted on the bottom surface of the heat dissipating portion 12, and the printed circuit boards 21 are parallel to the fins 15 on the heat dissipating portion 12. The heat dissipating portion 12 and the fins 15 dissipate heat generated by the LEDs 22 on the printed circuit boards 21. The reflector 50 is mounted on the LED modules 20 to reflect light generated by the LEDs 22.

The face plate 70 is U-shaped. In this embodiment, the face plate 70 is integrally formed of a metal with a good heat conductivity. The face plate 70 has a width as same as that of the heat sink 10 and a length as same as that of the heat sink 10. The face plate 70 has a main body 71, a front wall 72 and a rear wall 73 extending from two ends of the main body 71. The main body 71 defines a rectangular opening 710, for extension of light generated by the LED modules 20. A transparent plate 75 is attached on the main body 71 to cover the opening 710. The front wall 72 and the rear wall 73 intimately engage with the heat sink 10. The front wall 72 defines a groove 74 for intimately engaged with the connector 60. The front wall 72 defines a through hole 720 for extension of wires (not shown) therethrough.

The connector 60 comprises a middle portion 61, a top portion 62 extending from a top edge of the middle portion 61, and a connecting portion 63 perpendicularly extending from the middle portion 61. The middle portion 61 extends an insert 64 from a bottom thereof to engage in the groove 74 of the front wall 72. The top portion 62 defines a plurality of through holes 620 corresponding to the screw holes 130 of the mounting portion 13 of the heat sink 10. The connecting portion 63 has a cylindrical configuration for connecting a lamp pole (not shown).

Each lateral wall 40 has a plate-like shape. Each lateral wall 40 has a top edge 41 and a bottom edge 42 corresponding to lateral edges of the heat spreader 11 and the face plate 70, respectively. Each lateral wall 40 defines an annular groove 43 in an inner face thereof facing the heat sink 10. The annular groove 43 is adjacent to and extends along the top and bottom edges 41, 42 of each lateral wall 40. An annular waterproof gasket (not labeled) is received in each groove 43 and sandwiched between the lateral wall 40 and the lateral edges of the heat spreader 11 and the face plate 70. walls 40 and the heat sink 10. Each lateral wall 40 engages with the heat spreader 11 of the heat sink 10, the face plate 10 and the connector 60 via a plurality of screws (not labeled).

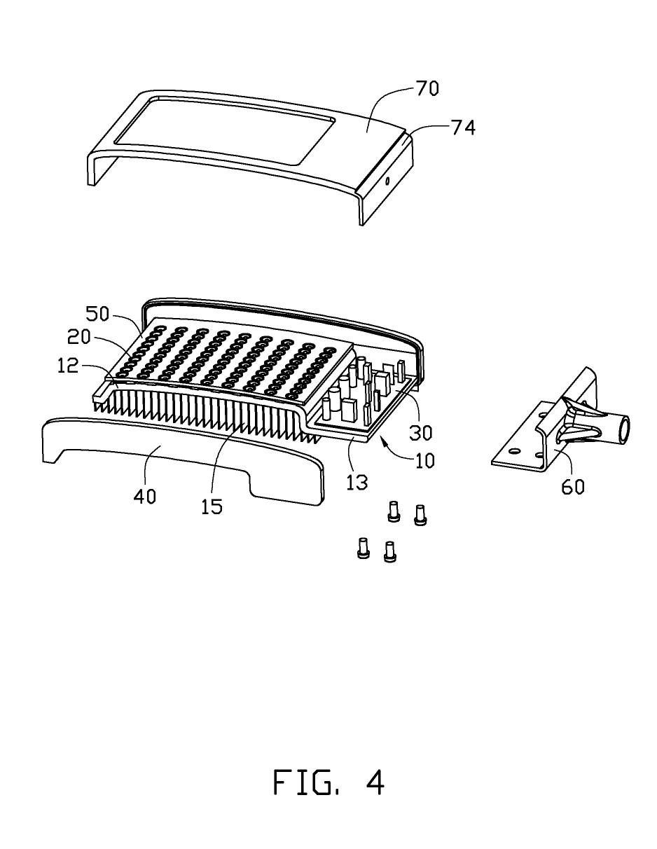

Referring to FIG. 4 also, in assembly, the LED modules 20 and the reflector 50 are mounted on the bottom of the heat dissipating portion 12 of the heat spreader 11. The driving circuit module 30 is mounted on the bottom surface of the mounting portion 13. The face plate 70 and the lateral walls 40 are mounted on the heat spreader 11 for enclosing the LED modules 20 and the driving circuit module 30 thereamong. Finally, a plurality of screws 90 secure the connector 60 on the mounting portion 13 of the heat sink 10.

In use, the heat generated by the LEDs 22 is transferred to fins 15 via the heat dissipating portion 12 of the heat spreader 11 and finally dissipates to ambient air. Since the fins 15 extend from the top of the lower dissipating portion 12 and the driving circuit module 30 is mounted on the bottom surface of the mounting portion 13, the LED lamp has a compact structure. The connector 60 is directly mounted on the aluminum extrusion type heat sink 10; thus, the LED lamp has a simple structure.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED (light emitting diode) lamp, comprising:
a heat sink comprising a heat spreader, the heat spreader having a heat dissipating portion curved downwardly and a mounting portion horizontally extending from an end of the heat dissipating portion, a plurality of fins upwardly extending from a curved top of the heat dissipating portion; and
a plurality of LED modules attached to a bottom of the heat dissipating portion of the heat spreader of the heat sink.

2. The LED lamp as claimed in claim 1, wherein the mounting portion is higher than the heat dissipating portion, the LED lamp further comprising a driving circuit module mounted on a bottom surface of the mounting portion, the driving circuit module being electrically connected with the LED modules.

3. The LED lamp as claimed in claim 1, further comprising a connector engaging with the mounting portion of the heat sink.

4. The LED lamp as claimed in claim 3, wherein the connector comprises a middle portion, a top portion extending from a top edge of the middle portion toward the mounting portion, and a connecting portion perpendicularly extending from the middle portion in a direction away from the mounting portion.

5. The LED lamp as claimed in claim 1, further comprising a face plate and two lateral walls mounted to lateral edges of the heat spreader and enclosing the LED module.

6. The LED lamp as claimed in claim 5, wherein the face plate has a width as same as that of the heat sink and a length as same as that of the heat sink.

7. The LED lamp as claimed in claim 1, wherein the fins are parallel to each other, the LED modules attached to the bottom of the heat dissipating portion of the heat spreader of the heat sink being parallel to the fins.

8. The LED lamp as claimed in claim 1, wherein the heat sink is an aluminum extrusion type heat sink which is extruded along a direction from a lateral side to another lateral side of the heat sink.

9. An LED (light emitting diode) lamp, comprising:
a heat sink comprising a heat spreader, the heat spreader having a heat dissipating portion and a mounting portion extending from an end of the heat dissipating portion, the heat dissipating portion being curved downwardly, a plurality of fins upwardly extending from a curved top of the heat dissipating portion;
a connector having a flat top portion engaging with a top of the mounting portion;
a plurality of LED module attached to a bottom of the heat dissipating portion of the heat spreader of the heat sink; and
a driving circuit module mounted on a bottom of the mounting portion of the heat spreader and electrically connecting the LED modules.

10. The LED lamp as claimed in claim 9, wherein the heat sink is an aluminum extrusion type heat sink which is extruded along a direction from a lateral side to another lateral side of the heat sink.

11. The LED lamp as claimed in claim 9, wherein the connector comprises a middle portion, a top portion extending from a top edge of the middle portion to connect with the mounting portion, and a connecting portion perpendicularly extending from the middle portion in a direction away from the mounting portion.
